(19) United States
(12) Patent Application Publication
(10) Pub. No.: US 2016/0049878 A1
(43) Pub. Date: Feb. 18, 2016

(54) POWER CONVERTER AND DRIVING METHOD FOR THE SAME

(71) Applicant: Samsung Electro-Mechanics Co., Ltd., Suwon-si (KR)

(72) Inventor: Gyu Min PARK, Suwon-si (KR)

(73) Assignee: Samsung Electro-Mechanics Co., Ltd., Suwon-si (KR)

(21) Appl. No.: 14/818,644

(22) Filed: Aug. 5, 2015

(30) Foreign Application Priority Data
Aug. 13, 2014 (KR) 10-2014-0104990

(51) Int. Cl. H02M 3/335

(52) U.S. Cl. CPC H02M 3/33546

(57) ABSTRACT

The object of the present invention is to provide a power converter with a wide range of an output voltage and a driving method for the same.

The present invention provides a power supply unit for outputting any one of a first voltage and a second voltage and a control unit for outputting a control signal to select any one of the first voltage and the second voltage to select an output terminal voltage of the power supply unit and to be supplied in the power supply unit.

### CROSS-REFERENCE TO RELATED APPLICATIONS

This application claims the benefit under 35 U.S.C. Section 119 of Korean Patent Application Serial No. 10-2014-0104990, entitled filed Aug. 13, 2014, which is hereby incorporated by reference in its entirety into this application.”

### BACKGROUND OF THE INVENTION

1. Field of the Invention

The present invention relates to a power converter and a driving method for the same.

2. Description of the Related Art

In general, a power converter for an LED lamp can maintain a uniform luminance by controlling the current supplied to an LED module constantly. The power converter for the LED can control the current supplied to the LED module constantly by using a method such as a pulse width modulation (PWM), a pulse frequency modulation (PFM) or the like. In case of the LED module, a Vf (LED Forward Voltage) may be determined according to the number of LED connected in series and/or in parallel and the consumption power of each LED. And, the power converter for the LED lamp has the range of the output voltage; and, if the Vf of the LED module is within the range of the output voltage, the power converter for the LED lamp allows the LED module to emit the desired light constantly by controlling the current supplied to the LED module. However, if the Vf of the LED module is out of the range of the output voltage, there is a problem that the power converter for the LED lamp cannot emit the light constantly since the current is not controlled.

### SUMMARY OF THE INVENTION

The present invention has been invented in order to overcome the above-described problems and it is, therefore, an object of the present invention to provide a power converter having a wide range of output voltage and a driving method for the same.

In accordance with a first embodiment of the present invention to achieve the object, there is provided a power converter including a power supply unit for outputting any one of a first voltage and a second voltage and a control unit for outputting a control signal to select any one of the first voltage and the second voltage to select an output terminal voltage of the power supply unit and to be supplied in the power supply unit.

In accordance with a second embodiment of the present invention to achieve the object, there is provided a power converter including a transformer, a rectifying unit for rectifying a current flowing in a secondary winding of the transformer, a capacitor provided with a first electrode connected to one end of the secondary winding and a second electrode connected to a second electrode and a switch connected to the rectifying unit, if turned on, for storing a third voltage corresponding to a first voltage generated in the secondary winding through the rectifying unit on the capacitor when a current flowing the secondary winding flows into a first direction, and for outputting the second voltage through the rectifying unit by summing the first voltage generated in the secondary winding and a third voltage stored on the capacitor when a current flowing in the secondary winding flows into a second direction different from the first direction.

In accordance with a third embodiment of the present invention to achieve the object, there is provided a method for driving a power converter including sensing a voltage applied to a load and transmitting at least one of a first voltage and a second voltage generated by controlling a current flowing in a secondary winding of a transformer in response to the sensed voltage to a load, wherein the second voltage is generated by summing a first voltage formed at the secondary winding and a third voltage.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a circuit diagram showing a power converter in accordance with one embodiment of the present invention;

FIG. 2 is a circuit diagram showing a first modification embodiment of a rectifying unit shown in FIG. 1;

FIG. 3 is a circuit diagram showing a second modification embodiment of a rectifying unit shown in FIG. 1;

FIG. 4 is a circuit diagram showing a third modification embodiment of a rectifying unit shown in FIG. 1; and

FIG. 5 is a flow chart showing a driving method for the poser converter in accordance with the embodiment of the present invention.

### DETAILED DESCRIPTION OF THE PREFERABLE EMBODIMENTS

A matter regarding to an operational effect including a technical configuration for an object of a controller and a power converter using the same in accordance with the present invention will be clearly appreciated through the following detailed description with reference to the accompanying drawings showing preferable embodiments of the present invention.

Further, in describing the present invention, descriptions of well-known techniques are omitted so as not to unnecessarily obscure the embodiments of the present invention. In the present specification, the terms “first,” “second,” and the like are used for distinguishing one element from another, and the elements are not limited by the above terms.

In the following detailed description of the present invention, reference is made to the accompanying drawings that show, by way of illustration, specific embodiments in which the present invention may be practiced. These embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments. The following detailed description is, therefore, not to be taken in a limiting sense, and the scope of the embodiments is defined only by the appended claims, appropriately interpreted, along with the full range of equivalents to which the claims are entitled. In the drawings, like numerals refer to the same or similar functionality throughout the several views.

Hereinafter, embodiments of the present invention will be described in detail with reference to the accompanying drawings so that those skilled in the art can easily practice the present invention.

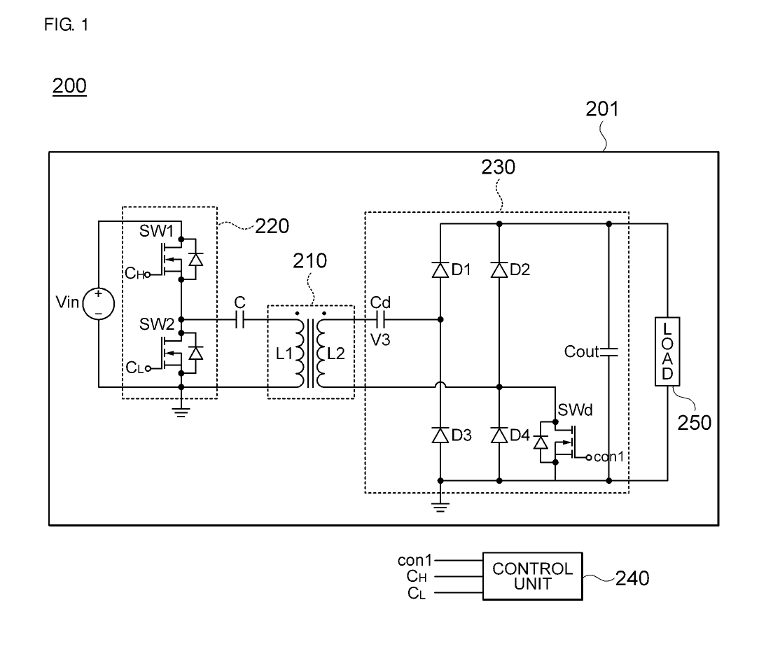

FIG. 1 is a circuit diagram showing a power converter in accordance with one embodiment of the present invention.

Referring to FIG. 1, a power converter 200 may include a power supply unit 201 for outputting any one of a first voltage and a second voltage and a control unit 240 for outputting a control signal (con1) to select any one of the first voltage supplied from the power supply unit 201 by sensing an output terminal voltage of the power supply unit 201 and the second voltage. And also, the power supply unit 201 may include a transformer 210, a power transform unit 220 for controlling a flow of a first current flowing in a primary winding (L1) of the transformer 210 and a rectifying unit 230 for storing a third voltage (V3) corresponding to a first voltage (V1) generated at a secondary winding (L2), if a flow of a second current flowing into the secondary winding (L2) of the transformer 210 is one direction, and for generating the first voltage (V1) stored at the secondary winding (L2), if the flow of the second current is another direction different from said one direction, and the second voltage (V2) obtained by summing a third voltage (V3) stored at a capacitor (Cd) to output.

The transformer 210 includes the primary winding (L1) and the secondary winding (L2), and the voltage may be generated in the secondary winding (L2) by the current flowing in the primary winding (L1). And also, the transformer 210 may be connected to a first electrode of the capacitor (Cd) at one end of the secondary winding (L2).

The power transform unit 220 can include a first switch (SW1) and a second switch (SW2) connected to an input voltage (Vin) in series. The first switch (SW1) and the second switch (SW2) may be alternately turned on by receiving a first switching signal (CH) and a second switching signal (CL), respectively. That is, if the first switch (sw1) is turned on, the second switch (SW2) is turned off; and, if the first switch (sw1) is turned off, the second switch (SW2) may be turned on. Herein, the second switching signal (CL) may be a signal obtained by inverting the first switching signal (CH). And also, the first switching signal (CH) and the second switching signal (CL) may be outputted at the control unit 240. However, it is not limited thereto.

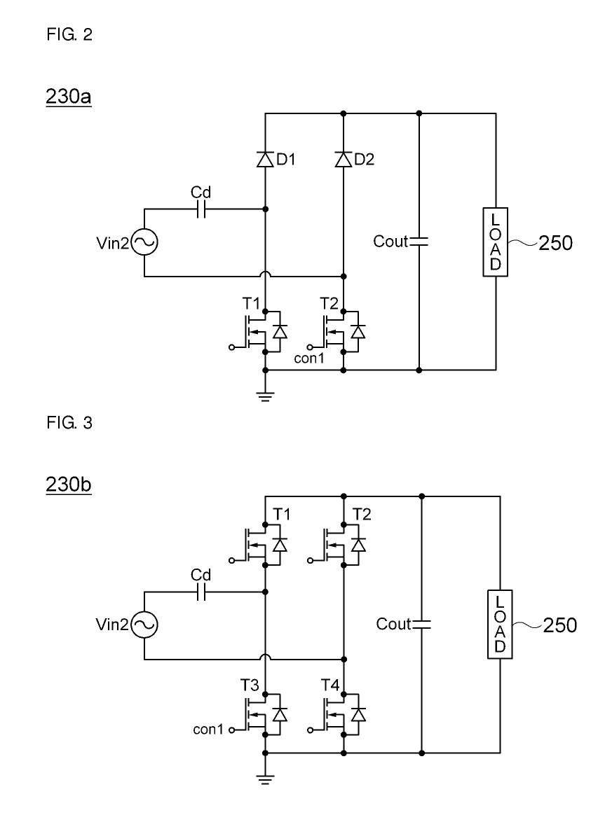

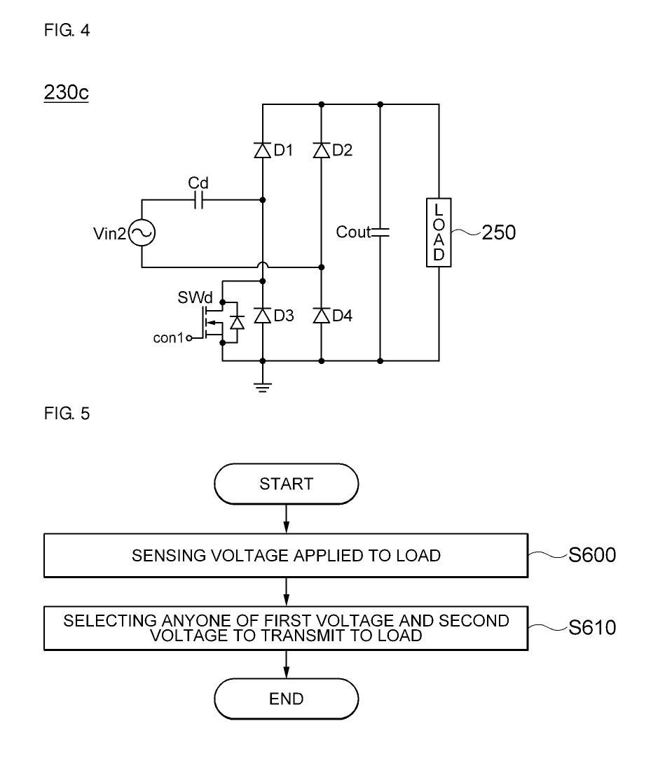

The rectifying unit 230 includes a first diode (D1) to a fourth diode (D4), an anode electrode of the first diode (D1) and a cathode electrode of a third diode (D3) are connected to a second electrode of the capacitor (Cd), and an anode electrode of the second diode (D2) and a cathode electrode of the fourth diode (D4) may be connected to the other end of the secondary winding (L2) of the transformer. Herein, although the rectifying unit 230 is shown as including the first diode (D1) to the fourth diode (D4), but it is not limited thereto, at least one among the first diode (D1) to the fourth diode (D4) may be constituted of FET, and a body diode of FET can be used for the rectification. The rectifying unit 230a shown in FIG. 1 represents that the third diode (D3) and the fourth diode (D4) are realized with a first FET (T1) and a second FET (T2) different from the rectifying unit 230 shown in FIG. 1. And, as the second FET (T2) receives a control signal (con1) to operate, the second FET (T2) operates the rectifying unit 230 as a synchronous rectifier as well as can select any one of the first voltage and the second voltage. And also, the rectifying unit 230b as shown in FIG. 3 implements the first diode (D1) to the fourth diode (D4) with the first FET (T1) to the fourth FET (T4), as the third FET (T3) receives the control signal (con1) to operate, the third FET (T3) operates the rectifying unit 230 as the synchronous rectifier as well as can select any one of the first voltage and the second voltage. And also, as shown in FIG. 4, in the rectifying unit 230c, the switch (SWd) may be connected to the third diode (D3) in series. However, the connection relationship the switch (SWd) and the diode or the FET is not limited thereto. And also, in FIG. 2 to FIG. 4, the input voltage (Vin2) may be a voltage applied to the secondary winding (L2) of the transformer 210 shown in FIG. 1.

Explaining the operation of the power converter 200 configured as above, the power transform unit 220 can control the turn on/off operations of the first switch (SW1) and the second switch (SW2) by receiving the first switching signal (CH) and the second switching signal (CL). The first switch (SW1) and the second switch (SW2) may be alternately turned on and off by the first switching signal (CH) and the second switching signal (CL). The ratio between the turn-on period and the turn-off period of the first switching signal (CH) and the second switching signal (CL) may be determined by corresponding the current flowing in a load 250. And also, if the first switch (SW1) is turned on and the second switch (SW2) is turned off by the first switching signal (CH) and the second switching signal (CL), the first current may flow in the primary winding (L1) of the transformer clockwise. Thereafter, the first switch (SW1) is turned off and the second switch (SW2) is turned on by the first switching signal (CH) and the second switching signal (CL), the first current may flow in the primary winding (L1) of the transformer counterclockwise. Since the primary winding (L1) and the secondary winding (L2) of the transformer 210 may be opposite in the winding direction, the direction of the second current flowing the secondary winding (L2) generated by the flow of the first current may be opposite to the direction of the first current flowing in the primary winding (L1). However, the winding direction of the secondary winding (L2) and the flowing direction of the second current are not limited thereto. And also, although the direction of the second current flowing in the counterclockwise of the secondary winding (L2) is referred to as the first direction and the direction of the second current flowing clockwise may be referred to as the second direction, but they are not limited thereto.

And, if the switch (SWd) is turned off by the control signal (con1), the rectifying unit 230 can perform the rectification. That is, if the second current flowing in the secondary winding (L2) flows clockwise, the second current may transmit to the load 250 through the first diode (D1). And, if the second current flowing in the secondary winding (L2) flows counterclockwise, the second current may transmit to the load 250 through the second diode (D2). However, if the switch is turned on by the control signal (con1) and the flow of the second current is the first direction, the rectifying unit 230 stores the third voltage (V3) corresponding to the first voltage (V1) generated in the secondary winding (L2); and, if the flow of the second current is the second direction different from the first direction, the second voltage (V2) obtained by summing the first voltage (V1) stored on the secondary winding (L2) and the third voltage (V3) stored on the capacitor (Cd) to output. At this time, the first voltage (V1) outputted in the power supply unit 201 or the second voltage (V2) is stored at the output capacitor and planarized to be outputted.

FIG. 5 is a flow chart showing a driving method for the poser converter in accordance with the embodiment of the present invention.

Referring to FIG. 5, a method for driving a power converter in accordance with the present invention includes the steps of sensing a voltage applied to a load 250 (S600) and generating the second voltage (V2) by summing the third voltage (V3) corresponding to the first voltage (V1) formed in the secondary winding (L2) of the transformer, wherein any one voltage of the first voltage (V1) generated by controlling the current flowing in the secondary winding (L2) of the transformer 210 corresponding to the sensed voltage and the second voltage (V2).

Although the method for sensing the voltage applied to the load 250 may be a method to sense the current flowing the load 250 and to sense the voltage corresponding to the sensed current, but it is not limited thereto. If the sensed voltage is above a predetermined value, it can be transmitted to the load 250 by selecting the second voltage (V2) obtained by summing the predetermined voltage to the first voltage (V1). And, when the current flows in one direction at the inductor (L) in the first voltage (V1), the second voltage (V2) may be a voltage to sum the third voltage (V3) corresponding to the first voltage (V1) generated at the secondary winding (L2) of the transformer. When the current flowing in the secondary winding (L2) of the transformer 210 in one direction as a method for summing the third voltage (V3) to the first voltage (V1), the third voltage (V3) corresponding to the first voltage (V1) is stored on the capacitor (Cd); and, if the direction of current flowing in the secondary winding (L2) of the transformer 210 changes, the second voltage (V2) can be transmitted to the load 250 by summing the first voltage (V1) generated at the secondary winding (L2) of the transformer 210 and the third voltage (V3) stored on the capacitor (Cd).

By the power converter and the driving method for the same in accordance with the embodiment of the present invention, since the range of the output voltage of the power converter is wide, they can perform the desired operation by connecting the loads such as an LED module with various consumption powers to one power converter.

Method of operation of the power converter in accordance with the present invention is implemented in program instruction from that can be executed various computer means may be recorded on computer readable media. The media may also include, alone or in combination with the program instructions, data files, data structures, and the like. The media and program instructions may be the kind well known and available to those skilled in the art, or computer software specifically designed and constructed for the purposes of the present invention. Examples of computer-readable media include hard disks, floppy disks, and magnetic media such as magnetic tapes (magnetic media), CD-ROM, an optical recoding medium such as a DVD, a magneto-optical media such as a floptical disk and a hardware device specially configured to store and perform the program instructions such as ROM, RAM, a flash memory or the like. Examples of program instructions include both containing higher level code that may be executed by the computer using an interpreter as machine code such as produced by a compiler. The described hardware devices may be configured to act as one or more software modules in order to perform the operations of the present invention, and vice versa.

In the claims hereof, any element expressed as a means for performing a specified function is intended to encompass any way of performing that function including, for example, a combination of circuit elements which performs that function or software in any form, including, therefore, firmware, microcode or the like, combined with appropriate circuitry for executing that software to perform the function.

Reference in the specification to “an embodiment” of the present principles, as well as other variations thereof, means that a particular feature, structure, characteristic, and so forth described in connection with the embodiment is included in at least one embodiment of the present principles. Thus, the appearances of the phrase “in an embodiment”, as well as any other variations, appearing in various places throughout the specification are not necessarily all referring to the same embodiment.

Reference in the specification to “connect” or “connecting”, as well as other variations thereof, means that an element is directly connected to the other element or indirectly connected to the other element through another element. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

What is claimed is:

1. A power converter comprising:
a power supply unit for outputting any one of a first voltage and a second voltage; and
a control unit for outputting a control signal to select any one of the first voltage and the second voltage to select an output terminal voltage of the power supply unit and to be supplied in the power supply unit.

2. The power converter according to claim 1, wherein the power supply unit further comprises a switch and selects any one of the first voltage and the second voltage by allowing the switch to be turn on or turn off by the control signal.

3. The power converter according to claim 2, wherein the power supply unit includes:
a transformer for generating the first voltage in response to an input voltage;
a rectifying unit for rectifying a flowing current formed at a secondary winding of the transformer; and
a capacitor arranged between the secondary winding and the rectifying unit,
wherein the rectifying unit rectifies the current at a state that the switch is turned off, if a flow of the current is a first direction at a state that the switch is turned on, a third voltage corresponding to the first voltage generated in the secondary winding is stored on the capacitor, and if a flow of the current is a second direction, the second voltage is generated and outputted by summing the third voltage stored on the capacitor to the first voltage generated at the secondary winding.

4. The power converter according to claim 2, wherein the switch unit is turned on, the transformer generate the first voltage in response to an input voltage according to a flow of current, and if the flow of current is a first direction a third voltage corresponding to the first voltage generated at the secondary winding is stored, if the flow of current is a second direction different from the first direction, the second voltage obtained by summing the first voltage generated at the secondary winding and the third voltage stored on the capacitor is generated and outputted.

5. The power converter according to claim 1, wherein the power supply unit includes:
a transformer;
a power transform unit for controlling a flow of a first current flowing in a primary winding of the transformer; and
a rectifying unit for storing a third voltage corresponding to a first voltage generated at a secondary winding if a flow of a second current flowing in the secondary winding of the transformer is a first direction and generating a second voltage obtained by summing a first voltage generated at the secondary winding and a third voltage stored at the capacitor to output if a flow of the second current is a second direction different from the first direction.

6. The power converter according to claim 5, wherein the power transform unit includes a first switch and a second switch, and the first switch and the second switch are alternately turned on/off to control a flow of the first current.

7. A power converter comprising:
a transformer;
a rectifying unit for rectifying a current flowing in a secondary winding of the transformer;
a capacitor provided with a first electrode connected to one end of the secondary winding and a second electrode connected to a second electrode; and
a switch connected to the rectifying unit, if turned on, for storing a third voltage corresponding to a first voltage generated in the secondary winding through the rectifying unit on the capacitor when a current flowing the secondary winding flows into a first direction, and for outputting the second voltage through the rectifying unit by summing the first voltage generated in the secondary winding and a third voltage stored on the capacitor when a current flowing in the secondary winding flows into a second direction different from the first direction.

8. The power converter according to claim 7, wherein the rectifying unit includes a first diode to a fourth diode, and
an anode electrode of the first diode and a cathode electrode of the third diode are connected to a second electrode and an anode electrode of the second diode and a cathode electrode of the fourth diode are connected to the other end of the secondary winding.

9. The power converter according to claim 7, wherein at least one of the first diode to the fourth diode is a body diode of a transistor.

10. The power converter according to claim 6, wherein the switch is connected to the third diode or the fourth diode in series.

11. A method for driving a power converter comprising:
sensing a voltage applied to a load; and
transmitting at least one of a first voltage and a second voltage generated by controlling a current flowing in a secondary winding of a transformer in response to the sensed voltage to a load,
wherein the second voltage is generated by summing a first voltage formed at the secondary winding and a third voltage.

12. The method for driving the power converter according to claim 11, wherein the third voltage is a voltage obtained by storing a voltage corresponding to a first voltage generated at the secondary winding when a current flowing the secondary winding flows into a first direction.

13. The method for driving the power converter according to claim 12, wherein the first voltage generated at the secondary winding is stored on a capacitor connected to the secondary winding.
